(19) United States
(12) Patent Application Publication
(10) Pub. No.: US 2022/0058485 A1
(43) Pub. Date: Feb. 24, 2022

(54) Data Generation Device, Predictor Learning Device, Data Generation Method, and Learning Method

(71) Applicant: Hitachi, Ltd., Chiyoda-ku, Tokyo (JP)

(72) Inventors: Yoshiyuki TAJIMA, Tokyo (JP); Yohei KONO, Tokyo (JP)

(21) Appl. No.: 17/414,705

(22) PCT Filed: Dec. 13, 2019
(86) PCT No.: PCT/JP2019/049023

§ 371 Date: Jun. 16, 2021

(30) Foreign Application Priority Data
Jan. 10, 2019 (JP) 2019-002436

(51) Int. Cl. G06N 3/08

(52) U.S. Cl. CPC G06N 3/08

(57) ABSTRACT

A data generation device generates a data set and includes: a perturbation generation unit that generates a perturbation set for deforming each element based on at least one of an input of each element of a training data set and information on the training data set; a pseudo data synthesis unit that generates a new pseudo data set different from the training data set from the training data set and the perturbation set; an evaluation unit that calculates a distributional distance of the training data set and the pseudo data set or an estimated amount of the distributional distance and a magnitude of perturbation of the pseudo data with respect to the training data obtained from the perturbation set; and a parameter update unit that updates a parameter used by the perturbation generation unit to generate the perturbation set so that the distributional distance of the training data set and the pseudo data set is close to each other and the magnitude or expected value of the perturbation becomes a predetermined target value.

### CROSS-REFERENCE TO RELATED APPLICATION

The application is based upon and claims the benefit of priority from Japanese Patent Application No. 2019-2436, filed Jan. 10, 2019, the entire contents of which are incorporated herein by reference.

### TECHNICAL FIELD

The present invention relates to a data generation device that generates data used for machine learning.

### BACKGROUND ART

Recently, systems and services to which machine learning is adopted are widely provided. For example, many companies conduct economic activities by operating a wide variety of physical assets such as devices, facilities and vehicles. These assets may malfunction or fail for electrical or mechanical reasons. For this reason, it is important to prevent large hindrance to operation by appropriate predictive or countermeasure treatments, that is, replacement of parts and consumables, replacement and repair of units, and the like. However, appropriate treatments may not be taken due to the complexity of assets and the shortage of skilled maintenance personnel and repairmen. Therefore, a system that supplements the work of maintenance personnel and workers and enables stable operation of assets by recommending appropriate treatments based on information such as past operating performance and repair history is considered.

In such a system and service to which the machine learning is adopted as described above, a predictor is constructed based on a framework called supervised learning or semi-supervised learning that learns a relationship between input and output from a training data set related to the input and the output. This predictor is required to have high predictive performance (generalization performance) for data not included in the training data set. Therefore, recently, various models of predictors beginning with neural networks have been proposed.

On the other hand, as another approach, there is a method of aiming at improving generalization performance by using a pseudo data set obtained by appropriately deforming or converting the training data set together with an original training data set for learning. Such pseudo data generation is called data augmentation. For example, in general, in the case of an image, it may augment the data by deforming the training data set by rotation, enlargement, reduction, movement, or the like. However, in many cases, for a plurality of pieces of data handled in the industry such as the above-mentioned operating performance and repair history, a heuristic data augmentation method that functions effectively such as an image may be unclear. Therefore, a method of augmenting the data by mixing a sample that follows a parametric distribution with the original training data set is adopted. For example, data can be augmented by adding elements of the sample that follows a normal distribution with a small standard deviation to elements of the original data. However, when the distribution of the data-augmented training data set is significantly different from the distribution of the original training data set, in some cases, the performance may deteriorate.

There are the following related arts as background technologies in this technical field. JP-A-2006-343124 discloses a technique which is as a technique for estimating a chemical substance concentration from a sensor response, “estimates a probability density function of an interpolation error by regarding the interpolation error of chemical data as a random variable. By repeating of generating a pseudo-random number vector according to the estimated probability density function of the interpolation error and adding the pseudo-interpolation error vector to the vector randomly selected from the vector on the interpolation curve surface to generate a new data vector multiple times, the pseudo data which is a large number of data vectors that reflect the characteristics of the interpolation error of interpolation curve surface is generated. The pseudo data is learned in the neural network. A sensor is adopted to an unknown test sample, and a sensor response is measured. The sensor response is input to the neural network which is in a learned state, and the unknown concentrations of a plurality of chemical substances are estimated from the output of the neural network.”

### SUMMARY OF INVENTION

### Technical Problem

However, in the technique disclosed in JP-A-2006-343124, a distribution regarding the error is estimated by a kernel density estimation method for a regression model of an input data set with respect to an output data set, and elements of a sample according to the estimated error distribution are added to the estimated amount, so that more complex data augmentation is achieved in comparison with a method of simply adding elements of a set obtained from a normal distribution to elements of an input data set, but a pseudo data set having a distribution greatly different from a distribution of an original input data set may be generated. In particular, when there exist places (single-peak places) where the input data is one-to-one with respect to the output data and places (multi-peak places) where the input data is one-to-many, since deformation is based on the same distribution in the above-mentioned technique, with respect to the one-to-one places, a relatively large deformation is made in the place where a small deformation is to be applied, and with respect to the one-to-many places, a relatively small deformation is made in the place where a large deformation is to be applied, so that there is a possibility that a pseudo data set may have a distribution significantly different from the original distribution. In addition, the kernel density estimation method has a problem that there are many factors to be selected, such as a need to select various kernels and kernel parameters (bandwidth in the case of Gaussian kernel) for the training data.

The present invention has been made in view of the above problems, and an object of the present invention is to provide a means for generating a pseudo data set that has a distribution not significantly different from an original distribution and is different from training data.

### Solution to Problem

A representative example of the invention disclosed in the present application is as follows. That is, a data generation device generating a data set and includes: a perturbation generation unit that generates a perturbation set for deforming each element based on at least one of an input of each element of a training data set and information on the training data set; a pseudo data synthesis unit that generates a new pseudo data set different from the training data set from the training data set and the perturbation set; an evaluation unit that calculates a distributional distance of the training data set and the pseudo data set or an estimated amount of the distributional distance and a magnitude of perturbation of the pseudo data with respect to the training data obtained from the perturbation set; and a parameter update unit that updates a parameter used by the perturbation generation unit to generate the perturbation set so that the distributional distance of the training data set and the pseudo data set is close to each other and the magnitude or expected value of the perturbation becomes a predetermined target value.

### Advantageous Effects of Invention

According to one aspect of the present invention, it is possible to generate pseudo data in which a distributional distance and a magnitude of perturbation are well-balanced and which has a distribution which is not different from a distribution of training data beyond a target perturbation amount. Problems, configurations, and effects other than those described above will be clarified by the description of the following embodiments.

### BRIEF DESCRIPTION OF DRAWINGS

FIG. 1 is a diagram illustrating a configuration of a recommendation system of the present embodiment.

FIG. 2 is a diagram illustrating an operation of a data generation/predictor learning unit of the present embodiment.

FIG. 3 is a diagram illustrating a hardware configuration of a computer constituting the recommendation system of the present embodiment.

FIG. 4 is a diagram illustrating an example of actual performance data of the present embodiment.

FIG. 5 is a diagram illustrating an example of repair work data of the present embodiment.

FIG. 6 is a diagram illustrating an example of a training data set of the present embodiment.

FIG. 7 is a flowchart of a process of a modeling phase in the present embodiment.

FIG. 8 is a flowchart of a learning process of the modeling phase in the present embodiment.

FIG. 9 is a flowchart of a recommendation process in the present embodiment.

FIG. 10 is a diagram illustrating a training data selection screen of the present embodiment.

FIG. 11 is a diagram illustrating a pseudo data confirmation screen of the present embodiment.

### DESCRIPTION OF EMBODIMENTS

Hereinafter, representative embodiments for carrying out the present invention will be described as appropriate with reference to the drawings.

### SUMMARY

The present invention relates to a machine learning device based on data, and particularly, to a device that generates other pseudo data based on given data and uses the pseudo data to learn a predictor having high generalization performance. In the present embodiment, when the above-mentioned asset malfunctions or fails, a data generation/predictor learning device related to learning of the predictor used in a recommendation system that recommends appropriate treatments based on information such as operating performance and repair history of the asset will be described.

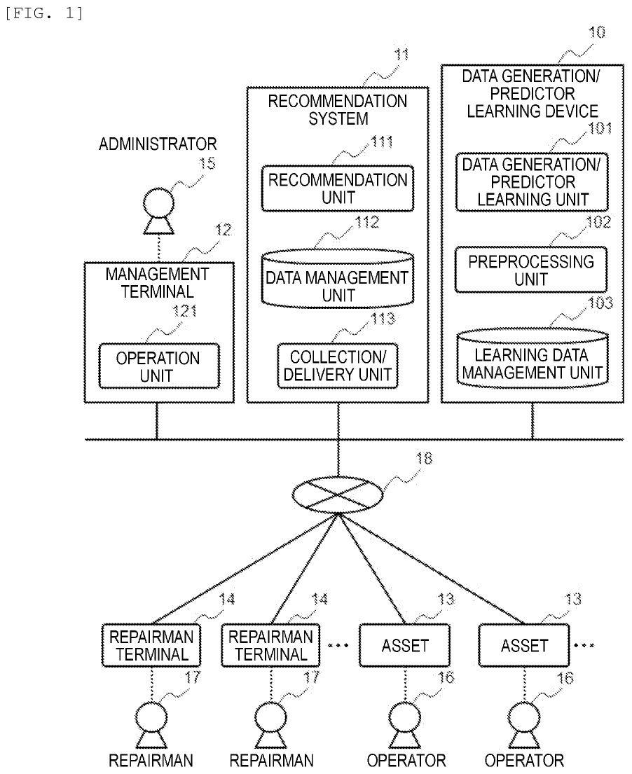

First, a flow of processes of the entire recommendation system will be described with reference to FIG. 1. First, the flow from collection of operating performance and repair history to predictor learning (referred to as a modeling phase) will be described. A recommendation system 11 collects operating performance, defect status, repair history, and the like from an asset 13, an operator 16 via the asset 13, and a repairman 17 via a repairman terminal 14 and collects actual performance data combining the collected information. Herein, the actual performance data includes, for example, operating time of the asset 13, information from a sensor attached to the asset 13, the defect status input by the operator 16 (for example, occurrence of abnormal noise), and information of repair work performed on the asset 13, and the like. Next, an administrator 15 selects the data to be used for data generation and predictor learning from the actual performance data collected by the recommendation system 11 via a management terminal 12. The recommendation system 11 extracts data according to the selection and transmits the extracted data as training data to a data generation/predictor learning device 10. The data generation/predictor learning device 10 generates data by using the received training data and creates a learned model. Then, the data generation/predictor learning device 10 returns the learned model (learned model) to the recommendation system.

Next, a flow of recommendation of repair contents (referred to as a recommendation phase) will be described. The recommendation system 11 collects actual performance data excluding repair work information from the asset 13, the operator 16 via the asset 13, and the repairman 17 via the repairman terminal 14. Next, the recommendation system 11 calculates one or a plurality of recommended repair work from the learned model and the actual performance data excluding the information on the repair work. Then, the result is presented to the repairman 17 via the repairman terminal 14.

Next, an outline of processes of the data generation/predictor learning device 10 will be described. The data generation/predictor learning device 10 receives the training data and creates the learned model. In the process, in order to construct a predictor with high generalization performance, three components: data generation, data evaluation, and a predictor are learned based on a framework of GAN (Generative Adversarial Networks) which is a type of deep learning. At that time, in general GAN, the pseudo data is directly generated, but in the present embodiment, the pseudo data is generated by once generating a perturbation and adding the generated perturbation to the original training data.

As a result, an objective function for perturbations can be added and learned, and the learned model can be created. In particular, in the present embodiment, on the premise of mini-batch learning, data generation is restricted so that the total sum of perturbations within the mini-batch is constant. Accordingly, it is possible to trade off the fact that the pseudo data becomes close to the training data in terms of a distributional distance and the fact that the pseudo data is deformed from the training data. As a result, unlike the case where the pseudo data is perturbed with a normal distribution, for example, when there is even a little movement, a variable that is impossible as training data is not formed, and the elements of the training data are hardly deformed, and so that performance deterioration due to data augmentation can be suppressed. At that time, degree of data augmentation can be controlled by changing the above-mentioned constants.

On the other hand, a simple learning method of the predictor is to learn the training data mixed with the pseudo data as a new training data set. In addition to this, since the pseudo data can be obtained by imposing perturbations to certain elements of the training data, when the pseudo data is regarded as unlabeled data, various methods of semi-supervised learning can be adopted. The predictor with higher generalization performance can be obtained, for example, by adding a process of match the output of the intermediate layer when inputting to the neural network (referred to as feature matching in this paper with reference to the expression in Improved Techniques for Training LANs).

In addition, according to a method such as a method of using the above-mentioned feature matching, a method of sharing a portion or all of neural networks of the predictor with the data evaluation, or a method of allowing the predictor to participate in the hostile learning of the GAN by a method such as Tiple GAN, the training data with no label can be used effectively. It is noted that, in the present embodiment, the description is made on the premise of data generation using GAN consistently, but other methods may be used.

<System Configuration>

A system configuration of the present embodiment will be described with reference to FIG. 1. The system of the present embodiment includes the data generation/predictor learning device 10, the recommendation system 11, the management terminal 12 operated by the administrator 15, the asset 13 operated by the operator 16, and the repairman terminal 14 operated by the repairman 17. These components of the system are connected to each other via a network 18. The network 18 itself can be configured with a LAN (Local Area Network), a WAN (Wide Area Network), or the like. It is noted that the system configuration described above is an example, and the components are not limited to those illustrated. For example, the data generation/predictor learning device 10 and the recommendation system 11 may be configured as one device, or the predictor learning device 10 may be divided into a plurality of devices for distributed processing.

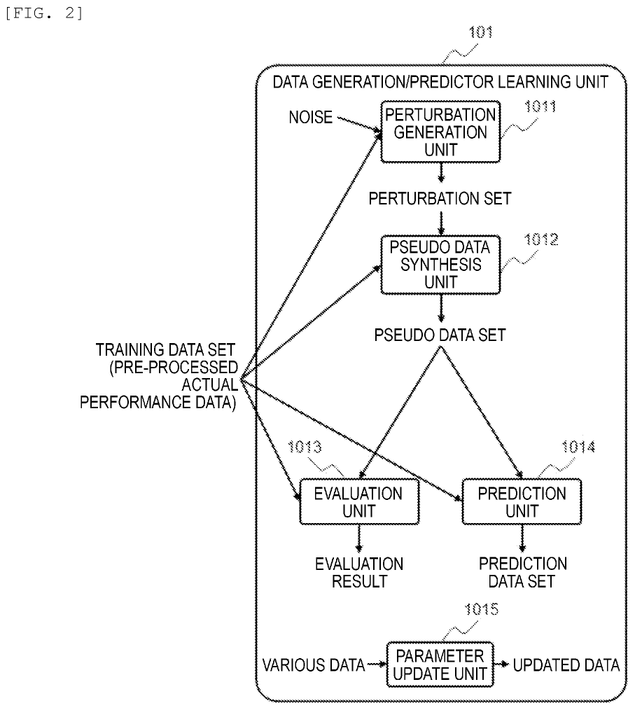

Next, details of a data generation/predictor learning unit 101 will be described with reference to FIG. 2. The data generation/predictor learning unit 101 includes a perturbation generation unit 1011, a pseudo data synthesis unit 1012, an evaluation unit 1013, a prediction unit 1014, and a parameter update unit 1015.

It is noted that, in the data generation/predictor learning unit 101, a data generation device is configured with the perturbation generation unit 1011, the pseudo data synthesis unit 1012, the evaluation unit 1013, and the parameter update unit 1015, and a predictor learning device is configured with the prediction unit 1014 and the parameter update unit 1015.

<Functions and Hardware>

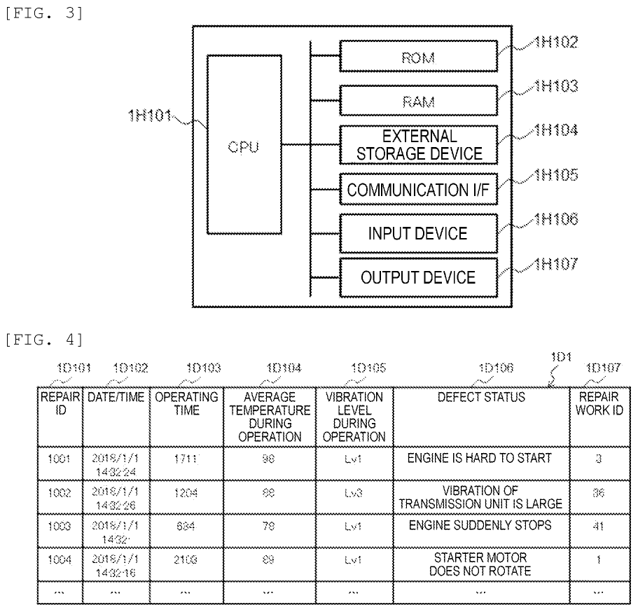

Next, correspondence between functions and hardware will be described with reference to FIGS. 1 and 3.

The data generation/predictor learning unit 101, a preprocessing unit 102, and a learning data management unit 103 included in the data generation/predictor learning device 10 are implemented by a CPU (Central Processing Unit) 1H101 reading a program stored in a ROM (Read Only Memory) 1H102 or an external storage device 1H104 into a RAM (Read Access Memory) 1H103 and controlling a communication I/F (Interface) 1H105, an input device 1H106 such as a mouse or keyboard, and an output device 1H107 such as a display.

A recommendation unit 111, a data management unit 112, and a collection/delivery unit 113 included in the recommendation system 11 are implemented by the CPU (Central Processing Unit) 1H101 reading the program stored in the ROM (Read Only Memory) 1H102 or the external storage device 1H104 into the RAM (Read Access Memory) 1H103 and controlling the communication I/F (Interface) 1H105, the input device 1H106 such as a mouse or a keyboard, and the output device 1H107 such as a display.

An operation unit 121 included in the management terminal 12 is implemented by the CPU (Central Processing Unit) 1H101 reading the program stored in the ROM (Read Only Memory) 1H102 or the external storage device 1H104 into the RAM (Read Access Memory) 1H103 and controlling the communication I/F (Interface) 1H105, the input device 1H106 such as a mouse or keyboard, and the output device 1H107 such as a display.

A portion or all of the processes executed by the CPU 1H101 may be executed by an arithmetic unit (ASIC, FPGA, or the like) configured with hardware.

The program executed by the CPU 1H101 is provided to the data generation/predictor learning device 10, the recommendation system 11, and the management terminal 12 via a removable medium (CD-ROM, flash memory, or the like) or a network and is stored in a non-volatile storage device which is a non-temporary storage medium. For this reason, a computer system may have an interface for reading data from a removable medium.

Each of the data generation/predictor learning device 10, the recommendation system 11, and the management terminal 12 is a computer system configured on one computer configured physically or on a plurality of computers configured logically or physically, and may operate on a virtual computer constructed on a plurality of physical computer resources.

<Data Structure>

Next, actual performance data 1D1 managed by the data management unit 112 of the recommendation system 11 will be described with reference to FIG. 4. The actual performance data 1D1 is the data obtained by collecting operating performance, defect status, repair history, and the like from the asset 13, the operator 16 via the asset 13, and the repairman 17 via the repairman terminal 14 and combining the collected data for each repair of the asset. The actual performance data 1D1 includes a repair ID 1D101 for specifying the repair unit, a date/time 1D102 when the repair has been performed, an operating time 1D103 from the installation or overhaul of the asset, an average temperature 1D104 during the operation, and a vibration level 1D105 during the operation, a defect status 1D106, and a repair work ID 1D107 for specifying the repair work performed. The repair work ID described later is associated with the work content performed, replacement parts, and the like.

In the present embodiment, the actual performance data 1D1 includes the above-mentioned items, but the actual performance data 1D1 may include other data related to the asset or may include a portion of the above-mentioned items.

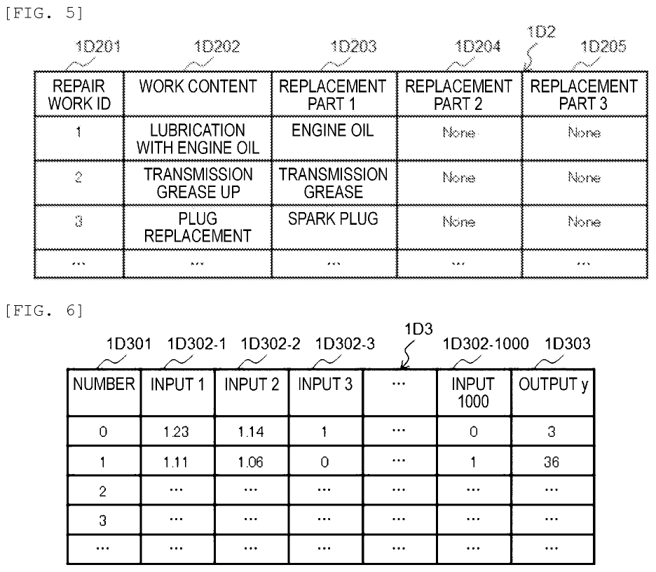

Next, repair work data 1D2 managed by the data management unit 112 of the recommendation system 11 will be described with reference to FIG. 5. The repair work data 1D2 includes a repair work ID 1D201 for specifying the repair work, a work content 1D202, and replacement parts 1D203 to 1D205. It is noted that, in the example illustrated in FIG. 5, replacement parts are recorded up to three, but the number of recorded replacement parts may be larger or smaller than three. In addition, the repair work data 1D2 may include the information on the repair work, for example, the information on tools and consumables to be used in addition to the work contents and the replacement parts.

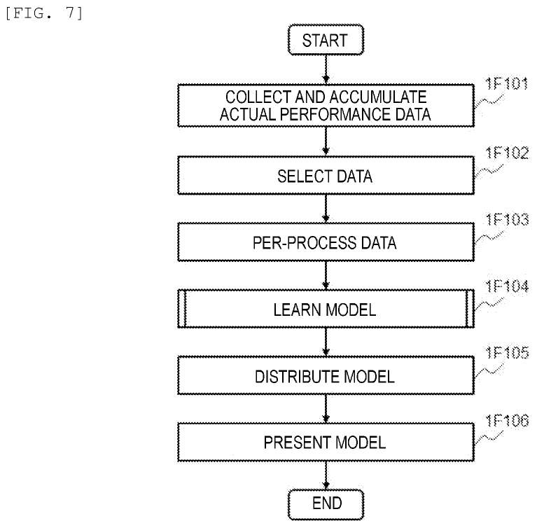

Next, a training data set 1D3 managed by the learning data management unit 103 of the data generation/predictor learning device 10 will be described with reference to FIG. 6. The training data set 1D3 is a piece of data in which the preprocessing unit 102 has pre-processed the date/time 1D102 and the operating time 1D103 of the actual performance data 1D1 selected based on the designation of the administrator 15 and includes a number 1D301 for identifying the data, inputs 1 to 1000 (1D302-1 to 1D302-1000) that are inputs of the predictor in which actual performance data is digitized, and an output y 1D303 which is an output of the predictor corresponding to the repair work ID. It is noted that, in the present embodiment, the number of inputs is 1000, but the number of input data may be more or less than 1000.

<Flow of Processes>

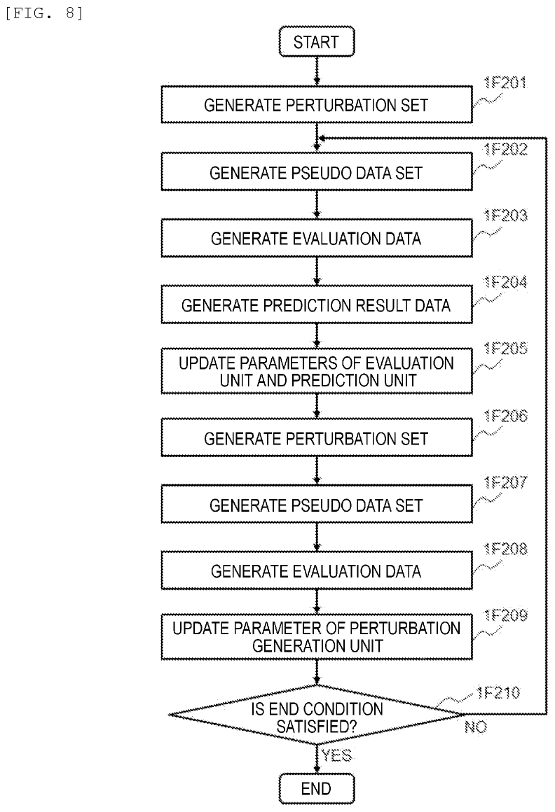

Next, processes of the modeling phase in the present embodiment will be described with reference to FIGS. 7 and 8.

An overall flow will be described with reference to FIG. 7. First, the collection/delivery unit 113 of the recommendation system 11 collects the actual performance data 1D1 from the asset and the repairman terminal 14 and accumulates the actual performance data 1D1 in the data management unit 112 (step 1F101).

Next, the operation unit 121 of the management terminal 12 receives conditions (period) and a perturbation parameter search range of the data, which is used for the data generation and the predictor learning from the actual performance data 1D1, from the administrator 15. Then, the collection/delivery unit 113 selects the actual performance data 1D1 satisfying the conditions from the data management unit 112 according to the received search conditions and stores the actual performance data 1D1 in the learning data management unit 103 of the data generation/predictor learning device 10 together with the perturbation parameter search range (step 1F102). The perturbation parameter search range is the range of γ in Mathematical Formula (5) described later.

Next, the preprocessing unit 102 of the data generation/predictor learning device 10 generates the training data set 1D3 by performing digitizing character strings and categorical variables, standardizing quantitative variables, and normalizing on the selected actual performance data 1D1 stored in the learning data management unit 103 and stores the training data set 1D3 in the learning data management unit 103 (step 1F103).

Next, the data generation/predictor learning unit 101 of the data generation/predictor learning device 10 executes a learning process related to the data generation and the prediction based on the training data set 1D3 and stores a generated model (referred to as a learned model) in the learning data management unit 103 (step 1F104). It is noted that the learning process will be described in detail with reference to FIG. 8.

Next, the learning data management unit 103 of the data generation/predictor learning device 10 distributes (stores a replica) the created model to the data management unit 112 of the recommendation system 11 (step 1F105).

Finally, the operation unit 121 of the management terminal 12 presents a pseudo data set generated by the learned model, the distributional distance of the training data set and the pseudo data set, and the like to the administrator 15 and ends the process. The administrator 15 can determine whether to change learning parameters described later, to adopt the learned model which is newly learned, or to continue to use the model in the related art based such presentation information.

Next, a learning process in the present embodiment will be described in detail with reference to FIG. 8. It is noted that, in the present embodiment, a mode using Wasserstein GAN (Generative Adversarial Network), which is one of GANs, is illustrated. First, symbols and the conditions related to the symbols will be described. In addition, instead of the Wasserstein GAN, other GAN methods such as Triple GAN may be used, or other methods such as MMD (Maximum Mean Discrepancy) may be used for the distributional distance and the amount related to the distributional distance. In addition, the specified perturbation parameter search range may be actually searched comprehensively by dividing the specified range of γ into 10 and performing a linear search, and the like, and the learned model with the highest generalization performance may be selected as the final learned model, but for the simplicity of description, the flow of processes when γ is 0.2 will be described below. It is noted that other parameters described later may be searched similarly to γ.

The set related to the input of the training data set 1D3 is denoted by X, and the distribution that the element x of the set imitates is denoted by Pr. In addition, the pseudo data set is denoted by Xg, and the distribution that the element xg of the set imitates is denoted by Pg. The Wasserstein distance between Pr and Pg is denoted by W (Pr, Pg). At this time, W (Pr, Pg) is expressed by Mathematical Formula (1).

$$[ Mathematical Formula 1 ]$$

$$W ( Pr , Pg ) = {sup}_{‖ {f}_{w} ‖ \leq 1} {E}_{x \sim Pr} [ {f}_{w} ( x ) ] - {E}_{x \sim Pg} [ {f}_{w} ( x ) ]$$

In Mathematical Formula (1), ∥fw∥≤1 indicates that a function fw is Lipschitz continuous. In addition, E [•] represents an expected value. In addition, the function fw is configured with a neural network, and w is a parameter of the neural network.

xg is x added with a perturbation Δx and satisfies the following.

xg=x+Δx=x+g_{θ}(x,z) [Mathematical Formula 2]

This perturbation Δx follows a conditional probability distribution Pp (Δx|x, z) of x and noise z. Herein, it is assumed that the noise z follows a normal distribution or a uniform distribution. In addition, g_{θ} is a function that generates a perturbation Δx according to Pp from certain x and z. It is noted that the function g_{θ} is configured with a neural network, and θ is a parameter of the neural network.

Next, the function for calculating an estimated value y^{p} of the output with respect to the input x is referred to as h_{ϕ}(x). A function h_{ϕ} is configured with a neural network, and ϕ is a parameter of the neural network. The process will be described by using the symbols described above.

First, the perturbation generation unit 1011 of the data generation/predictor learning unit 101 generates a perturbation set ΔX by extracting a subset X={xm: m=1, 2, 3, . . . , M} (mini-batch set, in the present embodiment M=100, but other values may be used) sampled from the training data set, sampling a set Z with a size M from the normal distribution, and applying the function go to the set Z (step 1F201).

Next, the pseudo data synthesis unit 1012 generates the pseudo data set Xg={xgm: m=1, 2, 3, . . . , M} by taking the sum of the elements of X and ΔX (step 1F202).

Next, the evaluation unit 1013 is obtained by applying the function fw to the Xg and using an estimated amount Wasserstein^{˜} of the Wasserstein distance, which is a kind of distributional distance, as one of the evaluation data by the following equation (step 1F203).

$$[ Mathematical Formula 3 ]$$

$${Wasserstein}^{\sim} = \frac{1}{M} {\sum }_{m = 1}^{M} {f}_{w} ( {x}_{m} ) - \frac{1}{M} {\sum }_{m = 1}^{M} {f}_{w} ( {xg}_{m} )$$

Next, the prediction unit 1014 of the data generation/predictor learning unit 101 generates a prediction data set Y′={y′_{m,c}: m=1, 2, 3, . . . , M} regarding X and a predicted output Y′g={yg′_{m,c}=1, 2, 3, . . . , M} regarding Xg by applying the function h_{ϕ} to the X and Xg (step 1F204). Herein, c denotes a class index, and in the present embodiment, c corresponds to a repair work ID.

Next, the parameter update unit 1015 of the data generation/predictor learning unit 101 updates the parameter w by an inverse error propagation method in the direction of maximizing the estimated amount Wasserstein^{˜} expressed by Mathematical Formula (3). Similarly, the parameter (I) is updated by the inverse error propagation method in the direction of minimizing a function CrossEntropyLoss expressed by Mathematical Formula (4) (step 1F205). The first and second terms of Mathematical Formula (4) indicate cross entropy. Herein, similarly to those described above, y_{m,c} are elements of an output data set Y={y_{m,c}: m=1, 2, 3, . . . , M} of the training data corresponding to X, and the index is the same as y′_{m,c} and yg′_{m,c}. In addition, α is a parameter for adjusting the balance between the parameter update derived from the training data set and the parameter update derived from the pseudo data set, and α is set to 0.5 in the present embodiment, but may be another value. The third term of Mathematical Formula (4) imposes a restriction that allows the internal state (output of the intermediate layer) of the perturbed network to be close. Herein, u^{p}_{m,c} and ug^{p}_{m,c} are the outputs of the intermediate layer immediately before the final layer (output layer) for the inputs of the training data set and the pseudo data set, respectively. β is a parameter for adjusting the influence of the restriction and is set to 0.5 in the present embodiment, but other values may be used. By the third term, it is possible to acquire a model with high generalization performance as compared with learning using data that has been simply augmented. It is noted that, when executing the inverse error propagation method in this step, it is preferable that the parameter θ of the perturbation generation unit 1011 is not updated.

$$[ Mathematical Formula 4 ]$$

$$CrossEntorpyLoss = - {\sum }_{m = 1}^{M} {\sum }_{c = 1}^{C} {y}_{m , c} log ( {y}_{m , c}^{′} ) - α {\sum }_{m = 1}^{M} {\sum }_{c = 1}^{C} {y}_{m , c} log ( {yg}_{m , c}^{′} ) + {β ( {u}_{m , c}^{p} - {ug}_{m , c}^{p} )}^{2}$$

Next, the perturbation generation unit 1011 of the data generation/predictor learning unit 101 generates the perturbation set in the same procedure as in step 1F201 (step 1F206).

Next, the pseudo data synthesis unit 1012 of the data generation/predictor learning unit 101 generates the pseudo data set in the same procedure as in step 1F202 (step 1F207).

Next, the evaluation unit 1013 of the data generation/predictor learning unit 101 obtains loss Adversarial related to the function go as another evaluation data by Mathematical Formula (5) by applying the function fw to Xg (step 1F208). Herein, g_{θ}(xm, z)=Δxm=xgm−xm. In addition, the first term of Mathematical Formula (5) is a term possessed by the loss function of the generator of the normal Wasserstein GAN and allows the distributional distance of the pseudo data set and the training data set to be close to each other. On the other hand, the second term is a term adopted in the present invention, and restricts the magnitude of perturbation (sum of absolute values) in the mini-batch so as to be a constant value γ·M. That is, the expected value of the magnitude of perturbation is restricted. As a result, there occurs a difference between the training data and the pseudo data. By the action of these two terms, it is possible to generate the pseudo data set which is not significantly different from the distribution of elements but different from the input data, which is the object of the present invention. Such a pseudo data set is not completely different from the distribution of elements, and thus, it is possible to suppress the deterioration of generalization performance due to data augmentation, and it is possible to generate the pseudo data which is conveniently used such as using the label of the data that is the element. It is noted that, by using λ, it can be controlled how much the finally generated pseudo data is different from the original training data. In the present embodiment, λ is set to 1.0, but other values may be used. It is noted that, as described above, γ is set to 0.2. Moreover, although the sum of the absolute values is used as the magnitude of the perturbation, an index of another magnitude such as an L2 norm may be used.

$$[ Mathematical Formula 5 ]$$

$$GeneratorLoss = - \frac{1}{M} {\sum }_{m = 1}^{M} {f}_{w} ( {xg}_{m} ) + λ \cdot {( ( {\sum }_{m = 1}^{M} \vert {g}_{θ} ( {x}_{m} , z ) \vert ) - γ \cdot M ) )}^{2}$$

Next, the parameter update unit 1015 of the data generation/predictor learning unit 101 updates the parameter θ by the inverse error propagation method in the direction of minimizing the Generator Loss expressed by Mathematical Formula (5) (step 1F209).

Next, the parameter update unit 1015 of the data generation/predictor learning unit 101 confirms whether an end condition is satisfied. In the present embodiment, it is assumed that the end condition is satisfied when the parameter is updated a predetermined number of times (for example, 10000 times). When the end condition is not satisfied, the process returns to step 1F201, and the process is continued. On the other hand, when the end condition is satisfied, the process of the model learning ends (step 1F210). It is noted that, as the end condition, the process may be determined to be ended at the timing when the size of the so-called loss function expressed by Mathematical Formula (4) is not decreased.

In addition, the perturbation generation unit 1011 generates the perturbation set ΔX by using the subset X related to the input of the training data set and the set Z sampled from the normal distribution, but the subset related to the output of the training data set may be added to the input. As a result, since the distribution of the output is taken into consideration, more appropriate pseudo data can be generated as a combined distribution of the input and the output.

In addition, an estimated amount of a probability density function such as k-neighbor density estimation regarding the input of the training data set may be added to the input. As a result, the learning of the perturbation generation unit 1011 can be accelerated and stabilized.

In addition, although the method of generating the perturbation without assuming a specific distribution structure has been described above, a specific distribution structure (for example, a parameter of a parametric distribution such as a normal distribution structure representing a posterior distribution of the perturbation set) may be assumed for the perturbation. In that case, when the distribution is a normal distribution with a mean of 0, the parameters of the distribution, for example, the variance can be the target of data generation. It is possible to improve the predictive performance by the perturbation in a low density portion, and thus, it is possible to speed up and stabilize the learning of the perturbation generation unit 1011.

In addition, when the target perturbation amount is changed from a small value to a large value, a good perturbation amount can be obtained by a linear search that stops just before the generalization performance starts to be decreased according to the change in the target perturbation amount.

In addition, in the present embodiment, since the label can be shared between the pseudo data and the data before perturbation, the outputs of the intermediate layer when the two pieces of data are input to the predictor can be close to each other, and thus, it is possible to improve the learning utilizing the feature matching.

In addition, although the training data set of the present embodiment is labeled, when some unlabeled data is included, the semi-supervised learning can be performed by using the parameter θ (perturbation generation unit 1011) and the parameter w (evaluation unit 1013) for the unlabeled data are also used for learning in the same procedure as that of the labeled data, and the parameter θ (prediction unit 1014) by learning in the same procedure as that of the labeled data for the third term of the mathematical expression (4). In addition, as in Tripe GAN described above, the semi-supervised learning may be performed by defining an objective function so that the predictor participates in hostile learning.

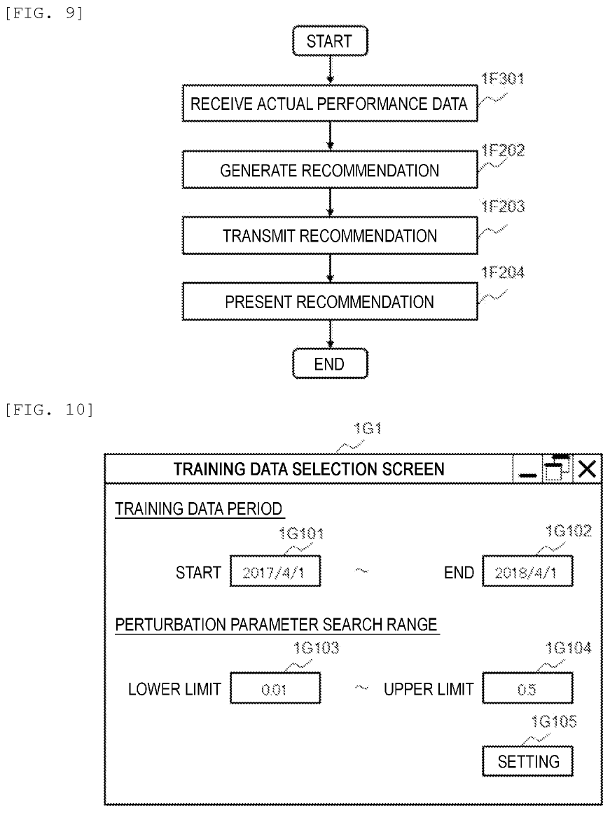

Next, a flow of a recommendation process will be described with reference to FIG. 9.

First, the collection/delivery unit 113 of the recommendation system 11 collects the actual performance data 1D1 in which the repair work ID is not described (None) from the asset 13 and the repairman terminal 14 regarding the asset 13 before repair (which will be a repair target in the future) (Step 1F301).

Next, the recommendation unit 111 of the recommendation system 11 performs the same preprocessing as the preprocessing unit 102 of the data generation/predictor learning device 10 and generates a predictive value (referred to as recommendation) of the repair work ID by using the learned model (step 1F302).

Next, the recommendation unit 111 and the collection/delivery unit 113 of the recommendation system 11 transmit the recommendation to the asset 13 and the repairman terminal 14 (step 1F203).

Finally, the asset 13 presents the recommendation to the operator 16, the repairman terminal 14 presents the recommendation to the repairman 17, and the process is ended (step 1F204).

As described above, the recommendation system 11 can promptly respond to malfunction or failure by collecting appropriate information from the asset 13 and the repairman terminal 14 and presenting repair recommendation. It is noted that, in the present embodiment, the recommendation system 11 actively generates and presents the recommendation, but the process of generating and presenting the recommendation in response to the request of the operator 16 or the repairman 17 may be executed.

<User Interface>

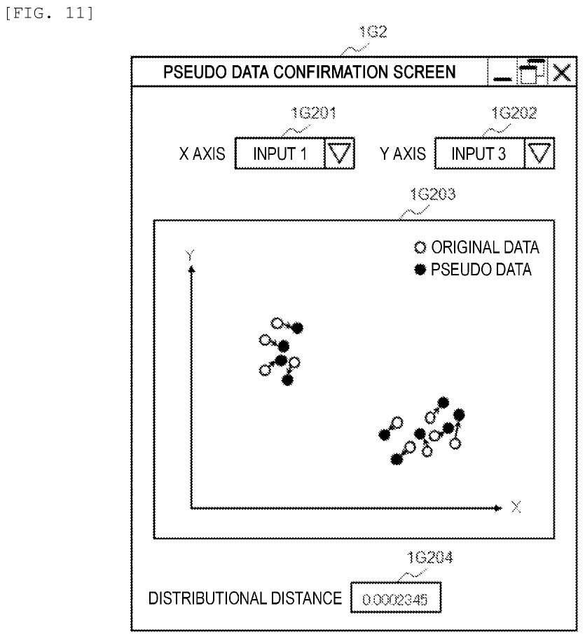

Next, a training data selection screen 1G1 used by the administrator 15 for selecting the actual performance data 1D1 used for data generation and predictor learning will be described with reference to FIG. 10. The training data selection screen 1G1 is displayed on the operation unit 121 of the management terminal 12.

The training data selection screen 1G1 includes a period start date setting box 1G101, a period end date setting box 1G102, a perturbation parameter search range lower limit setting box 1G103, a perturbation parameter search range upper limit setting box 1G104, and a setting button 1G105.

By designating the start date in the period start date setting box 1G101 and designating the end date in the period end date setting box 1G102, the actual performance data 1D1 of the period from the start date to the end date is selected as the training data.

By setting the lower limit of the perturbation parameter search range in the perturbation parameter search range lower limit setting box 1G103 and setting the upper limit of the perturbation parameter search range in the perturbation parameter search range upper limit setting box 1G104, the best model can be learned by changing the total amount of perturbation. In addition, instead of setting the lower limit and the upper limit of the perturbation parameter search range as illustrated in the figure, a setting box for setting the perturbation parameter may be provided.

When the setting button 1G105 is operated (for example, clicked), the period of the actual performance data 1D1 used for the above-mentioned learning and the perturbation parameter search range are stored in the learning data management unit 103 of the data generation/predictor learning device 10.

Next, a pseudo data confirmation screen 1G2 used by the administrator 15 for visually confirming the pseudo data generated by the learned model will be described with reference to FIG. 11. The pseudo data confirmation screen 1G2 is displayed on the operation unit 121 of the management terminal 12.

The pseudo data confirmation screen 1G2 includes an X-axis component designation list box 1G201, a Y-axis component designation list box 1G202, a comparison view 1G203, and a distributional distance box 1G204.

In the X-axis component designation list box 1G201, an input (for example, an input 1) of the pre-processed training data 1D3 assigned to the X-axis of the comparison view 1G203 is set. Similarly, in the Y-axis component designation list box 1G202, an input (for example, an input 3) of the pre-processed training data 1D3 assigned to the Y-axis of the comparison view 1G203 is set. As a result, the pre-processed training data 1D3 (original data in the figure) regarding the two set inputs and the generated pseudo data are displayed in the comparison view 1G203 as a scatter diagram. By viewing the comparison view 1G203, the administrator 15 can visually confirm how the input data has been augmented. This can be determined that, for example, data is to be additionally collected at places where a small number of data is often scattered.

On the other hand, in the distributional distance box 1G204, the distributional distance for all inputs calculated by the MMD is displayed. This can be used to confirm the degree to which the pseudo data differs from the original pre-processed training data 1D3. Herein, the evaluation result of the evaluation unit 1013 may be used, but since the estimated amount of the Wasserstein distance learned differs depending on the learning conditions, the MMD is used in the present embodiment.

As described above, according to the embodiment of the present invention, since the parameter update unit 1015 updates the parameter used for the generation of the perturbation set by the perturbation generation unit 1011 so that the distributional distances of the training data set and the pseudo data set approach each other to allow the magnitude or expected value of the perturbation to be predetermined target values, in consideration of the characteristics of each element of the given training data set, it is possible to add the perturbation so that the distributional distance of the pseudo data as a whole with respect to the training data set or the estimated amount related to the distributional distance is reduced, and it is possible to generate the pseudo data that does not differ from the distribution of training data beyond the target perturbation amount.

In addition, since the perturbation generation unit 1011 generates the perturbation set based on the input of each element of the training data set or the information on the training data set and the output of each element of the training data set or the information on the training data set, in terms of the trade-off between the distributional distance and the magnitude of the perturbation, it is possible to generate more reasonable pseudo data as the combined distribution of the input and the output considering the distribution of the output.

In addition, since the perturbation generation unit 1011 generates the perturbation set based on the estimated amount of the probability density function (for example, k-neighbor density estimation) regarding the input of the training data set in addition to the input of each element of the training data set or the information on the training data set, it is possible to speed up and stabilize the learning of the perturbation generation unit 1011.

In addition, since the perturbation generation unit 1011 generates the perturbation set by generating a parameter of a parametric distribution (for example, a normal distribution) representing the posterior distribution of the perturbation set, it is possible to improve the predictive performance by the perturbation in low density portion, and thus, it is possible to speed up and stabilize the learning.

In addition, since the display data (training data selection screen 1G1) of the interface screen on which the parameter value or the range of the parameter used by the perturbation generation unit 1011 can be input is generated, it is possible to impose the conditions for learning the best model by changing the perturbation amount.

In addition, since the display data of the scatter diagram illustrating each element of the training data set and each element of the pseudo data set is generated, it is possible to confirm how the input data is augmented.

In addition, since the prediction unit 1014 performs learning by using the pseudo data and the training data generated by the data generation device described above, it is possible to improve the predictive performance, and it is possible to speed up and stabilize the learning.

In addition, since the prediction unit 1014 is configured with a neural network, and an objective function (for example, the third term of Mathematical Formula (4)) in which a small difference between internal states when the training data is input and when the pseudo data is input is set to be good is added, it is possible to acquire a model with higher generalization performance. It is noted that the objective function may be a function in which the difference between the internal states of the two pieces of pseudo data generated from certain training data is small.

It is noted that the present invention is not limited to the above-described embodiments and includes various modifications and equivalent configurations within the scope of the attached claims. For example, the above-described embodiments have been described in detail in order to describe the present invention for easy understanding, and the present invention is not necessarily limited to those having all the described configurations. In addition, a portion of the configuration of one embodiment may be replaced with the configuration of other embodiments. In addition, the configuration of other embodiments may be added to the configuration of one embodiment. In addition, other configurations may be added, deleted, and replaced with respect to a portion of the configurations of each embodiment.

In addition, a portion or all of the above-described configurations, functions, processing units, processing means, and the like may be implemented by hardware, for example, by designing an integrated circuit and the like and may be implemented by software by allowing a processor to interpret and execute the program implementing each function.

Information such as programs, tables, and files that implement each function can be stored in a memory, a hard disk, a storage device such as an SDS (Solid State Drive), or a recording medium such as an IC card, an SD card, or a DVD.

In addition, the control lines and information lines that are considered to be necessary in terms of description are indicated and it is not necessarily indicate all the control lines and information lines necessary in terms of implementation. In practice, it can be considered that almost all of configurations are interconnected.

1. A data generation device generating a data set, comprising:
a perturbation generation unit that generates a perturbation set for deforming each element based on at least one of an input of each element of a training data set and information on the training data set;
a pseudo data synthesis unit that generates a new pseudo data set different from the training data set from the training data set and the perturbation set;
an evaluation unit that calculates a distributional distance of the training data set and the pseudo data set or an estimated amount of the distributional distance and a magnitude of perturbation of the pseudo data with respect to the training data obtained from the perturbation set; and
a parameter update unit that updates a parameter used by the perturbation generation unit to generate the perturbation set so that the distributional distance of the training data set and the pseudo data set is close to each other and the magnitude or expected value of the perturbation becomes a predetermined target value.

2. The data generation device according to claim 1,
wherein the perturbation generation unit generates the perturbation set based on an output of each element of the training data set or information on the training data set in addition to an input of each element of the training data set or information on the training data set.

3. The data generation device according to claim 1,
wherein the perturbation generation unit generates the perturbation set based on an estimated amount of a probability density function regarding an input of the training data set in addition to an input of each element of the training data set or the information on the training data set.

4. The data generation device according to claim 1,
wherein the perturbation generation unit generates the perturbation set by generating a parameter of a parametric distribution representing a posterior distribution of the perturbation set.

5. The data generation device according to claim 1,
wherein display data of an interface screen capable of inputting a parameter value or a range of the parameter value used by the perturbation generation unit is generated.

6. The data generation device according to claim 1,
wherein display data of a scatter diagram in which each element of the training data set and each element of the pseudo data set are represented is generated.

7. (canceled)

8. (canceled)

9. A data generation method of allowing a calculator to generate a data set,
wherein the calculator has an arithmetic unit that executes a predetermined arithmetic process and a storage device that the arithmetic unit can access, and
wherein the data generation method includes:
a perturbation generation procedure in which the arithmetic unit generates a perturbation set for deforming each element based on at least one of an input of each element of a training data set and information on the training data set;
a pseudo data synthesis procedure in which the arithmetic unit generates a new pseudo data set different from the training data set from the training data set and the perturbation set;
an evaluation procedure in which the arithmetic unit calculates a distributional distance of the training data set and the pseudo data set or an estimated amount of the distributional distance and a magnitude of perturbation of the pseudo data with respect to the training data obtained from the perturbation set; and
a parameter update procedure in which a parameter used to generate the perturbation set in the perturbation generation procedure is updated so that the distributional distance of the training data set and the pseudo data set is close to each other and the magnitude or expected value of the perturbation becomes a predetermined target value.

10. The data generation method according to claim 9,
wherein in the perturbation generation procedure, the arithmetic unit generates the perturbation set based on an output of each element of the training data set or the information on the training data set in addition to an input of each element of the training data set or the information on the training data set.

11. The data generation method according to claim 9,
wherein in the perturbation generation procedure, the arithmetic unit generates the perturbation set by generating a parameter of a parametric distribution representing a posterior distribution of the perturbation set.

12. The data generation method according to claim 9, wherein the arithmetic unit includes a procedure for generating display data of an interface screen capable of inputting a parameter value or a range of the parameter used in the perturbation generation procedure.

13. The data generation method according to claim 9, wherein the arithmetic unit includes a procedure for generating display data of a scatter diagram in which each element of the training data set and each element of the pseudo data set are represented by the arithmetic unit.

14. A learning method of allowing a calculator to learn a data set,
wherein the calculator includes an arithmetic unit that executes a predetermined arithmetic process and a storage device that the arithmetic unit can access, and
wherein the arithmetic unit executes learning in a prediction unit that predicts an output from an input of data not included in a training data set by using the pseudo data generated by the data generation method according to claim 9 and the training data.

15. The learning method according to claim 14,
wherein an objective function in which a small difference between internal states when the training data is input and when the pseudo data is input and a small difference between internal states of two pieces of pseudo data generated from the training data are set to be good is added.
